(19) United States
(12) Patent Application Publication
(10) Pub. No.: US 2013/0016081 A1
(43) Pub. Date: Jan. 17, 2013

(54) DISPLAY APPARATUS HAVING UNIFORMITY CORRECTION FUNCTION AND CONTROL METHOD THEREOF

(71) Applicants: Ji-yong PARK, Suwon-si (KR); Nam-kyun BEON, Seoul (KR); Sang-Kyun IM, Seoul (KR); Dong-wook KIM, Suwon-si (KR)

(72) Inventors: Ji-yong PARK, Suwon-si (KR); Nam-kyun BEON, Seoul (KR); Sang-Kyun IM, Seoul (KR); Dong-wook KIM, Suwon-si (KR)

(73) Assignee: SAMSUNG ELECTRONICS CO., LTD., Suwon-si (KR)

(21) Appl. No.: 13/546,392

(22) Filed: Jul. 11, 2012

(30) Foreign Application Priority Data
Jul. 11, 2011 (KR) 10-2011-0068307

(51) Int. Cl. G09G 5/10; G09G 5/02

(52) U.S. Cl. 345/207

(57) ABSTRACT

A display apparatus having a uniformity adjustment function is provided, which includes a display unit which is divided into a plurality of local areas; a signal receiver which receives from a sensor light intensity data of each local area of the display unit; and a controller which analyzes the plurality of local areas for non-uniformity correction by comparing a first light intensity data of a current local area with second light intensity data of local areas which have been previously analyzed for the non-uniformity correction, and uses calibration information of a previously analyzed local area if its second light intensity data is within an error range of the first light intensity data, and performs a calibration process with respect to the current local area if there is no result within the error range, and outputs an image signal to the display unit.

### CROSS-REFERENCE TO RELATED APPLICATION

This application claims priority from Korean Patent Application No. 10-2011-0068307, filed on Jul. 11, 2011 in the Korean Intellectual Property Office, the disclosure of which is incorporated herein by reference in its entirety.

### BACKGROUND

1. Field

Apparatuses and methods consistent with the exemplary embodiments relate to a display apparatus having a uniformity adjustment function and a control method thereof, and more particularly, to a display apparatus which reduces time for adjusting non-uniformity and a control method thereof.

2. Description of the Related Art

An image which is displayed by a display apparatus has a variation in luminance and color due to its electrical, physical and optical properties and the nature of such variation varies by each position of a screen displaying an image. Generally, variation in luminance occurs by 40%, which causes spatial non-uniformity of color. The uniformity in a display apparatus, such as a monitor for professional purposes, and broadcasting reference television (TV) or a large format display (LFD) is a particularly important factor. For example, the uniformity required for a broadcasting reference TV is 95% or more in luminance.

To satisfy the specifications required for optical, electrical, and physical properties of a display apparatus (such as a liquid crystal display (LCD), a plasma display panel (PDP) or an organic light-emitting diode (OLED) display), a large amount of expenses are required. Accordingly, signal processing is preferably used to satisfy the specifications.

In the case of the signal processing, an external calibrator is used to measure X, Y and Z factors, and non-uniformity is corrected by using the measured information. To correct the non-uniformity, the screen of the display apparatus is divided into many local areas, which are calibrated.

However, according to the non-uniformity correction method in the related art, the calibration process is performed to all of local areas. As a result, the entire calibration time becomes longer as there are a number of local areas, which requires longer non-uniformity correction time.

### SUMMARY

One or more exemplary embodiments provide a display apparatus and a control method thereof which omits a calibration process for similar local areas of which light intensity is within an error range in consideration of properties of local areas of the display apparatus and performs a non-uniformity correction process by using calibration information analyzed previously to thereby reduce the entire non-uniformity correction time.

According to an aspect of an exemplary embodiment, there is provided a display apparatus having a uniformity adjustment function, the display apparatus including: a display unit which is divided into a plurality of local areas; a signal receiver which receives from a sensor light intensity data of each local area of the plurality of local areas of the display unit; and a controller which analyzes the plurality of local areas for non-uniformity correction by comparing a first light intensity data of a current local area with second light intensity data of local areas which have been previously analyzed for the non-uniformity correction, and, if any of the previously analyzed local areas is determined to have the second light intensity data within an error range of the first light intensity data of the current local area, the controller uses calibration information of the determined previously analyzed local area as calibration information for the current local area, and, if none of the previously analyzed local areas are determined to have the second light intensity data within the error range of the first light intensity data of the current local area, performs a calibration process with respect to the current local area, and outputs an image signal to the display unit.

The sensor may include a calibrator.

The display unit may be divided into a plurality of local areas by a user's setting.

The display apparatus may further include a computer, and the computer may store therein the light intensity data of each of the local areas input by the sensor before transmitting the light intensity data to the display apparatus.

The light intensity data may include color information and luminance information, and the controller may compare the color information and luminance information with color information and luminance information of local areas analyzed previously.

The controller may compare the color information with color information of local areas analyzed previously and perform a calibration process with respect to both color and luminance of the local area if there is no result within a first error range, and upon receiving a result within the first error range, the controller may compare the luminance information with luminance information of local areas analyzed previously and perform the calibration process with respect to the luminance of the local area and uses calibration information of the previous local area with respect to color if there is no result within a second error range, and use calibration information of the previous local area with respect to both color and luminance if there is any result within the second error range.

The display apparatus may further include a storage unit, and the storage unit may store therein color information, luminance information and calibration information of each local area.

The calibration information may include a coefficient value to adjust an RGB value of each pixel in the local area.

The controller may repeat a uniformity adjustment until a last local area is compared to each of the previously analyzed local area.

According to an aspect of an exemplary embodiment, there is provided a uniformity adjustment method of a display apparatus, the method including: dividing a display unit of the display apparatus into a plurality of local areas; measuring a light intensity of each of the plurality of local areas by using a sensor; comparing a first light intensity data measured for a current local area with second light intensity data of local areas which have been previously analyzed for the non-uniformity correction; if any of the previously analyzed local areas is determined to have the second light intensity data within an error range of the first light intensity data of the current local area, using calibration information of the determined previously analyzed local area as calibration information for the current local area, and, if none of the previously analyzed local areas are determined to have the second light intensity data within the error range of the first light intensity data of the current local area, performing a calibration process with respect to the local area; and stopping the uniformity adjustment if a last local area is compared.

The sensor may include a calibrator.

The light intensity data of each of the local areas may include color information and luminance information, and the color information and luminance information may be compared with color information and luminance information of local areas analyzed previously.

The calibration process may be performed with respect to both color and luminance of the local area if there is no result within a first error range after comparing the color information with the color information of the local areas analyzed previously, and the method may include comparing the luminance information with luminance information of local areas analyzed previously if there is any result within the first error range and performing a calibration process with respect to luminance of the local area and using calibration information of the previous local area with respect to color if there is no result within a second error range, and using calibration information of the previous local area with respect to both color and luminance if there is any result within the second error range.

The dividing the display unit into a plurality of local areas may include generating a memory to store therein information of each local area, and the information of each local area may include color information, luminance information and calibration information.

The calibration information may include a coefficient to adjust an RGB value of each pixel in the local area.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates a display apparatus which has a uniformity adjustment function according to an exemplary embodiment;

FIG. 2 is a block diagram of the display apparatus which has the uniformity adjustment function according to the exemplary embodiment;

FIG. 3 illustrates the display apparatus which displays local areas to which a calibration process is performed according to the exemplary embodiment;

FIG. 4 illustrates the display apparatus which shows a non-uniformity property according to the exemplary embodiment;

FIG. 5 is a flowchart which illustrates a uniformity adjustment method of the display apparatus according to the exemplary embodiment; and

FIG. 6 is a flowchart of a calibration process performed according to a comparison result of color and luminance information and information of previous local areas according to the exemplary embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

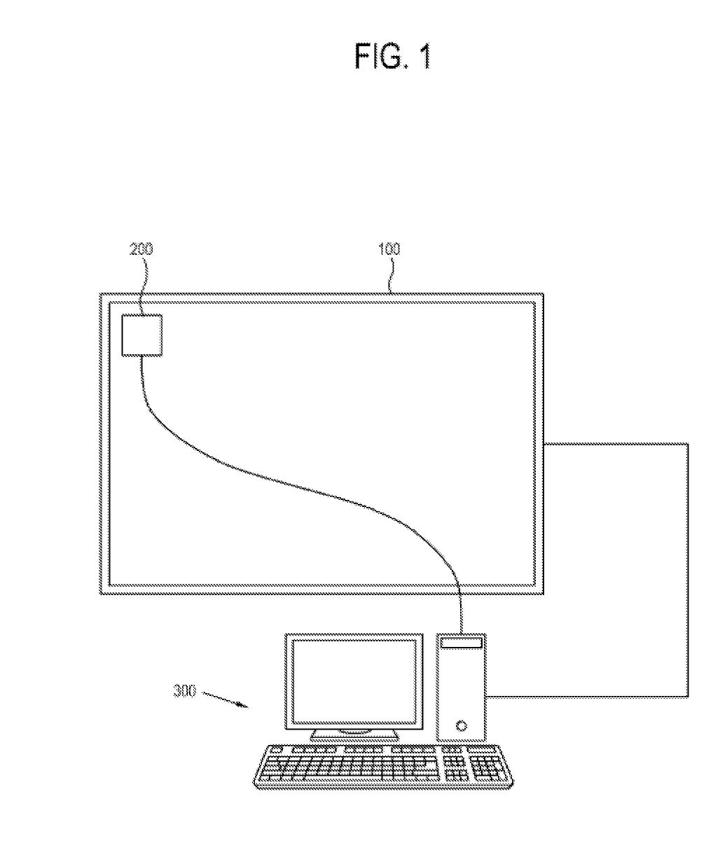

FIG. 1 illustrates a display apparatus which has a uniformity adjustment function according to an exemplary embodiment.

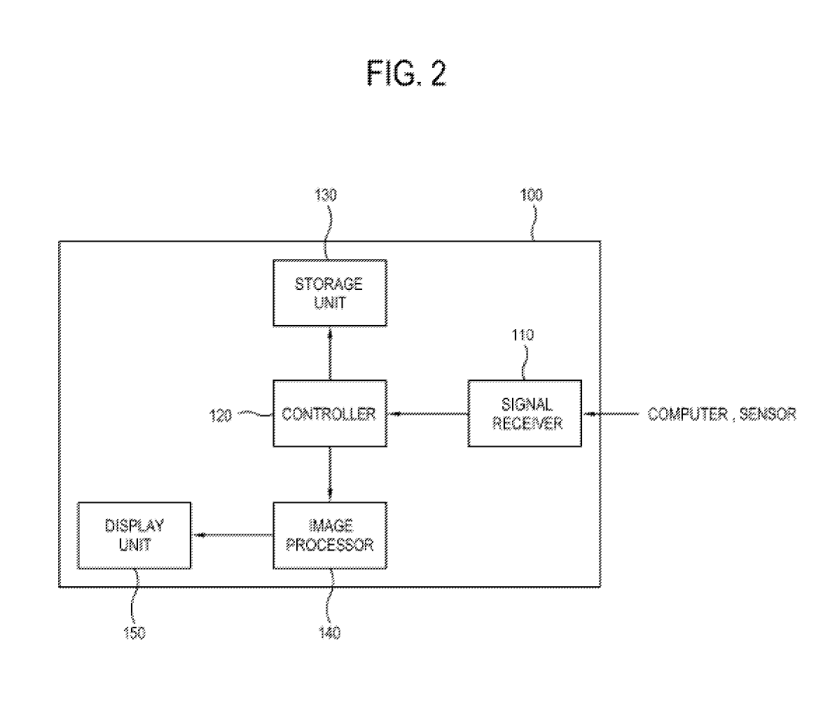

Referring to FIG. 1, a display apparatus 100 may receive from a computer 300 light intensity data of the display apparatus 100 measured by a sensor 200. According to another exemplary embodiment, the sensor 200 may be directly connected to the display apparatus 100 and the display apparatus 100 may directly receive from the sensor 200 the light intensity data of the display apparatus 100 measured by the sensor 200. A panel (i.e., display unit 150 in FIG. 2) of the display apparatus 100 may be divided into a plurality of local areas according to a user's setting. A user may measure light intensity of each local area of the panel with the sensor 200. The light intensity measured for each local area is transmitted to the computer 300. The light intensity data of each local area transmitted to the computer 300 is stored by the computer 300 and transmitted by the computer 300 to the display apparatus 100 after the completion of measurement. The display apparatus 100 may be a monitor, a TV, a large format display (LFD), a public information display (PID), or the like. The sensor 200 includes a calibrator. The calibrator is an external sensor which measures light intensity, and more specifically, measures X, Y and Z factors. The X and Z factors refer to color, and the Y factor refers to intensity to luminance.

FIG. 2 is a block diagram of the display apparatus having the uniformity adjustment function according to the exemplary embodiment.

Referring to FIG. 2, the display apparatus 100 includes a signal receiver 110, a controller 120, a storage unit 130, an image processor 140 and a display unit 150.

The display unit 150 is divided into a plurality of local areas. The division and the number of divided local areas may be adjusted by a user's setting. The signal receiver 110 receives light intensity data on light emitted from each of the local areas of the display unit 150. The signal receiver 110 may receive the light intensity data from the computer 300. For example, the computer 300 stores the light intensity data of each of the local areas detected and input by the sensor 200, and transmits such light intensity data for the plurality of local areas to the signal receiver 110 when the sensor 200 completes the measurement of the light intensity for each of the local areas.

The controller 120 receives light intensity data for a plurality of local areas from the signal receiver 110, and subsequently analyzes the local areas to determine whether a non-uniformity correction needs to be performed on each of the local areas by comparing the light intensity data, one-by-one, for each of the local areas with light intensity data of local areas that have been previously analyzed for non-uniformity correction. For example, when a third local area among the plurality of local areas is being analyzed by the controller, a first and a second have been previously analyzed by the controller and have their light intensity data stored in the storage unit 130. The controller then compares the light intensity data of the third local area with the light intensity data of the all the previously analyzed local areas (e.g., the first and the second local areas). Accordingly, during the comparison, the controller compares the light intensity data of the current local area with the light intensity data of previously analyzed local areas by searching the storage unit for previously measure local areas that have light intensity data that is within an acceptable error range of the light intensity data of the current local area. If the current local area is determined to have light intensity data which is within the error range of the searched local areas (i.e., the previously analyzed local areas), the controller 120 omits a calibration process for the local area, and performs a non-uniformity correction process by using calibration information of the determined local area. If the current local area is determined to not have light intensity data which shows similar intensity within the error range of the searched local areas, the controller 120 performs a calibration process for the local area and performs a non-uniformity correction process. The controller 120 repeatedly performs the non-uniformity correction process until reaching the last local area of the display unit 150.

If the controller 120 completes the non-uniformity correction process, an image signal having an adjusted RGB value for each pixel is output to the image processor 140. The image processor 140 processes a received image and outputs the processed image to the display unit 150.

The light intensity data includes color information and luminance information. The storage unit 130 stores therein the color information and the luminance information for a plurality of local areas received from the sensor 200 or the computer 300.

The controller 120 subsequently compares the color information and the luminance information of each of the local areas stored in the storage unit 130 with color information and luminance information of local areas previously analyzed. If it is determined that the color information and the luminance information of a local area does not have a similar intensity within the error range of the color information and the luminance information of the local areas previously analyzed, the controller 120 performs a calibration process for the local area to adjust the light intensity and stores calibration information generated by the calibration process in the storage unit 130. For example, if the display unit 150 is divided into 10×7 local areas, the storage unit 130 stores therein color information, luminance information and calibration information for 70 local areas.

The calibration refers to a process of adjusting an RGB value for adjusting light intensity for each local area. For example, if the measured light intensity of a first local area is 200 cd, it may be adjusted to 180 cd. If the light intensity measured from a lighter second local area is 300 cd, the light intensity of the second local area may be adjusted to 180 cd. Then, the light intensity of the monitor is adjusted to the same level as a whole to make the color of the monitor uniform. 180 cd explained above is an example, and the value may be set by a user. More specifically, the light intensity is adjusted by adjusting the RGB value of each pixel. The RGB value of each pixel ranges from zero to 255. To reduce the light intensity from 200 cd to 180 cd, the RGB value of each pixel should be adjusted. The light intensity may be reduced from 200 cd to 180 cd by reducing the RGB value of each pixel from 255 to 250. The adjustment of the RGB value for adjusting the light intensity for the local area is called calibration. A coefficient value, 250/255, which is information after adjustment of the RGB value is calibration information for the corresponding local area.

Since reducing the light intensity from 300 cd to 180 cd means reducing the light intensity further than from 200 cd to 180 cd, the RGB value may be reduced from 255 to 230. The coefficient value, 230/255, which is information after performance of the calibration for adjusting the RGB value of the pixel is calibration information for the corresponding local area. This calibration information may be used in other local areas. The foregoing figure is an example for explaining the exemplary embodiment.

For example, if similar light intensity data within the error range with respect to a local area having a light intensity of 200 cd is not found in the storage unit among the light intensity date of previously analyzed local areas, the controller 120 performs a calibration process for the local area and adjusts the light intensity from 200 cd to 180 cd, which serves as a reference value. If the light intensity of the local area is adjusted from 200 cd to 180 cd, the calibration information of the local area is 250/255 as described above. The storage unit 130 stores therein the coefficient value as the calibration information in addition to color information and luminance information. If the calibration process is performed, the RGB value of the pixel is adjusted corresponding to the adjustment range of light intensity of the local area, and the calibration information is stored as adjustment information of the RGB value. If the calibration process is omitted with respect to the local area and the previous calibration information is used, the previous calibration information of a previously analyzed local area corresponding to the error range is stored in the storage unit 130 for the local area, and the RGB value of the pixel of the local area is multiplied by the previous calibration information to adjust the light intensity.

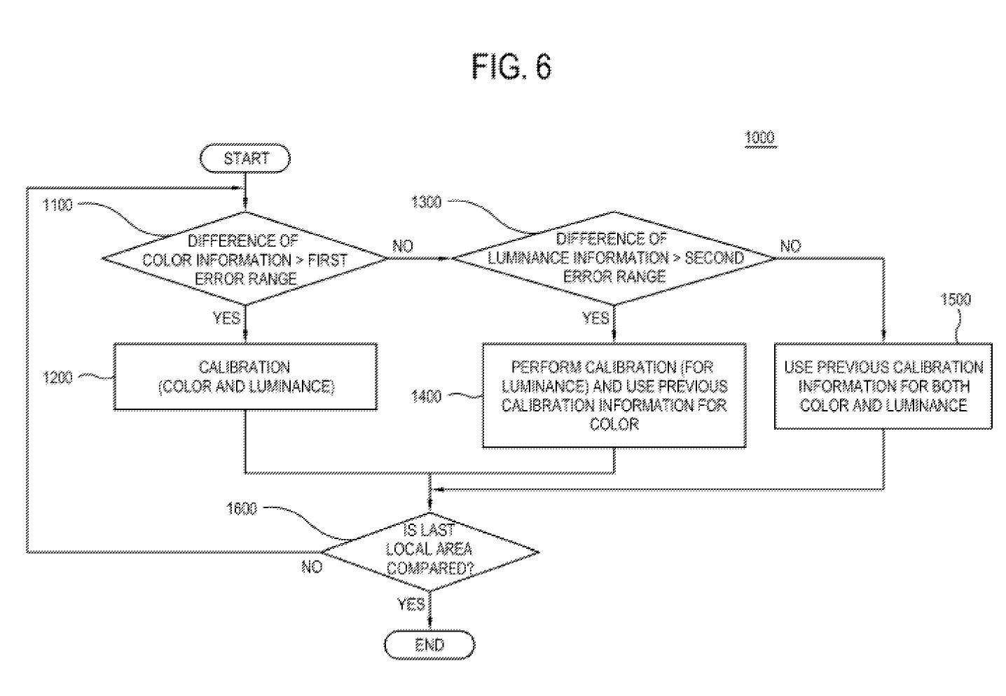

When analyzing a current local area, the controller 120 may compare the color information and luminance information of the current local area stored in the storage unit 130 with previously stored color information and luminance information of the local areas that have already been measured and analyzed. If the color information is compared and the difference of the color information is within a first error range, the luminance information may be compared subsequently. According to another exemplary embodiment, if the luminance information is compared and the difference of luminance information is within the first error range, the color information may be compared subsequently. This will be described later in more detail with reference to FIG. 6.

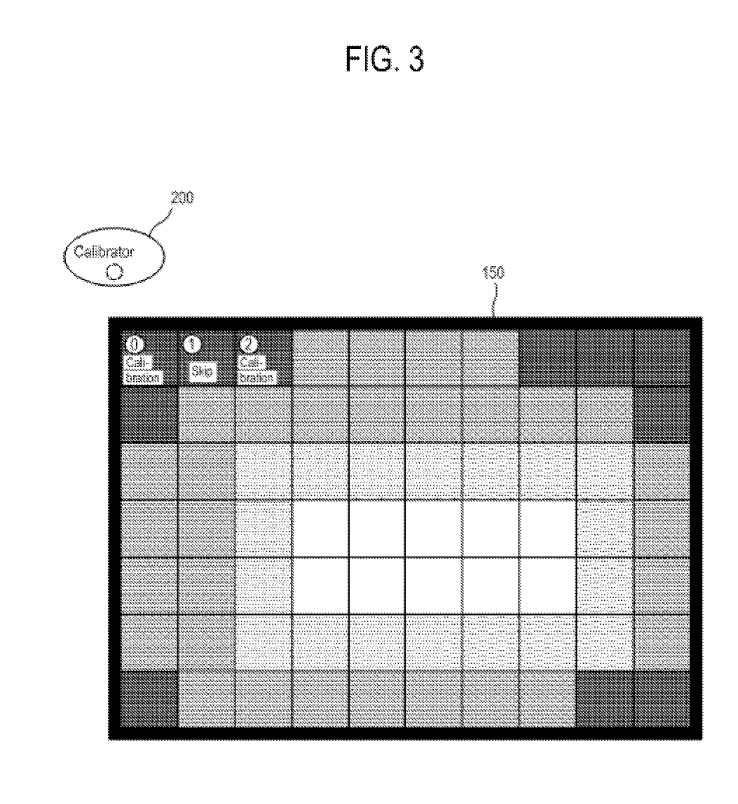

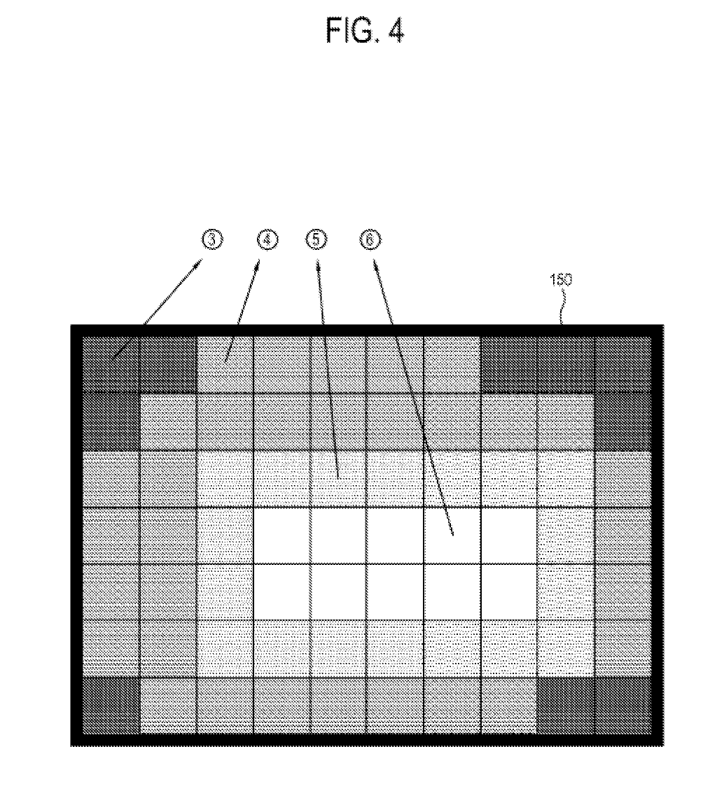

FIG. 3 illustrates an example of the display apparatus displaying the plurality of local areas for which the calibration process is performed according to the exemplary embodiment. FIG. 4 illustrates an example of the display apparatus which shows a non-uniformity property according to the exemplary embodiment.

Referring to FIG. 3, the local areas of the display unit 150 may be set with 10×7 areas. A user may repeatedly measure light intensity of the local areas from the left upper areas to the right side of the display unit 150 (i.e., the top or first row) and then a next line (i.e., a second row from left to right) after measuring the last local area on the right side of the first row through a calibrator 200. The sequence of measuring the light intensity of each local area may be different from the foregoing sequence.

The controller 120 compares light intensity data of a local area 0 of the display unit 150 stored in the storage unit 130 with light intensity data of the local areas measured previously stored in the storage unit 130. Since there is no previous light intensity data for the local area 0, the calibration process is performed with respect to the local area 0. The calibration process is performed and the light intensity is adjusted to a preset level to perform the non-uniformity correction.

For example, if a light intensity of the local area 0 is 200 cd, the RGB value of the pixels in that local area is reduced from 255 to 250 to reduce the light intensity by 20 cd to adjust the light intensity to a preset reference value of 180 cd, and 250/255 is stored as calibration information. Then, the controller 120 compares a next local area, i.e., local area 1 with the previously analyzed local areas (e.g., local area 0). If a light intensity of the local area 0 is 210 cd, it corresponds to an area having similar light intensity within an error range when being compared with the light intensity of the local area 0 measured previously.

Accordingly, the controller 120 omits or skips the calibration process for the local area 1, and adjusts the RGB value and the light intensity of local area 1 by using 250/255 as the calibration information of the local area 0 stored in the storage unit 130. Then, a local area 2 is compared. That is, light intensity data of the local area 2 stored in the storage unit 130 is subsequently compared with light intensity data of the local areas measured previously (e.g., local areas 0 and 1). If a light intensity of the local area 2 is 300 cd, it is determined that the light intensity data of local area 2 is out of the error range when compared with the previous local areas (nos. 0 and 1) and the calibration process is performed to the local area 2. If the calibration process is performed, the RGB value is adjusted to reduce the light intensity of the local area 2 from 300 cd to 180 cd. The light intensity is reduced by reducing the RGB value of the pixels in local area 2 from 255 to 230, and 230/255 is stored as calibration information. After the calibration process is completed for the local area 2, a next local area is compared, and so on. That is, a light intensity of the next local area is compared with light intensity of local areas 0, 1 and 2. As the light intensity of the local areas 0 and 1 is out of the error range and the light intensity of the local area 2 is within the error range, the RGB value is adjusted by using the calibration information of the local area 2. This process is repeated until the last local area of the display unit 150 is compared with the previously analyzed local areas.

Referring to FIG. 4, the light of the local areas of the display unit 150 may be divided into four levels. The local area 3 and an adjacent local areas are the darkest areas, the light intensity of which are within the error range of each other. The local area 4 and adjacent local areas are brighter than the local area 3, light intensity of which are within the error range of each other. The local area 5 and adjacent local areas are brighter than the 4 local area 4, the light intensity of which are within the error range of each other. The local area 6 and adjacent local areas are the brightest areas, the light intensity of which are within the error range of each other. It is presumed that the differences of light intensity among the local areas 3 to 6 are out of the error range for each other.

Accordingly, the calibration process is performed once when the light intensity of the local area 3 is searched, once when the light intensity of the local area 4 is searched, once when the light intensity of the local area 5 is searched and once when the light intensity of the local area 6 is searched, and a total of four calibration processes are performed. As the number of the entire local areas is 70 areas, it takes a quite long time to perform the calibration process for each of the 70 local areas. According to the exemplary embodiments, however, the calibration process is performed just four times, and the local areas within the error range are adjusted by using the previous calibration information to thereby reduce non-uniformity correction time.

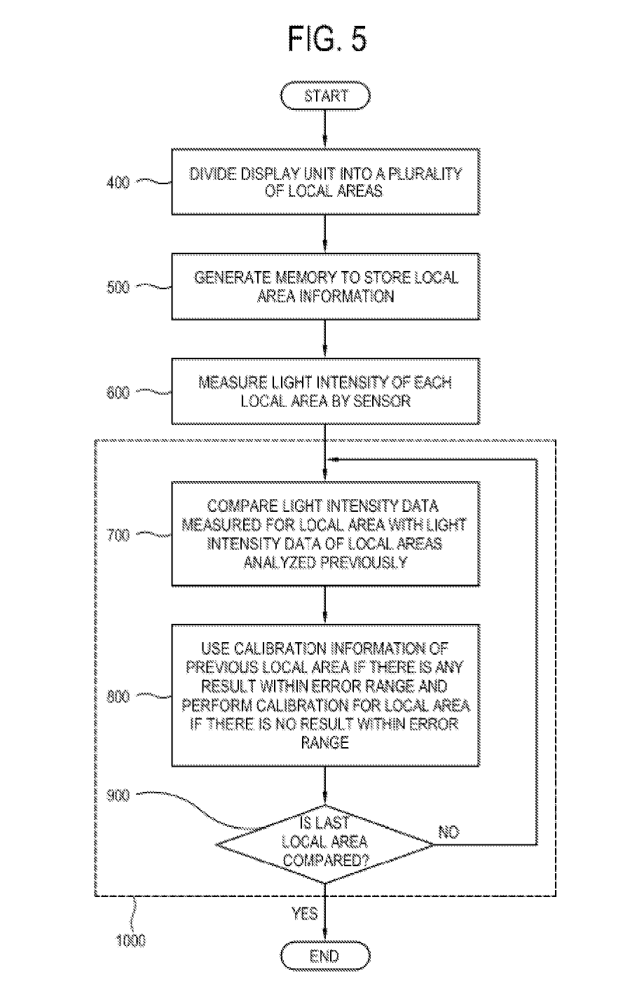

FIG. 5 is a flowchart of a uniformity adjustment method of the display apparatus according to the exemplary embodiment of the present invention. FIG. 6 is a flowchart of a calibration process according to a comparison result of color and luminance information with information of previous local areas according to the exemplary embodiment of the present invention.

Referring to FIG. 5, a user divides the display unit 150 of the display apparatus 100 into a plurality of local areas (400). A user may set the number of local areas through a remote controller or an input unit (not shown) of the display apparatus 100. If the display unit 150 is divided into a plurality of local areas, a memory storing the local area information therein is generated in the storage unit 130 (500). The local area information includes color information, luminance information and calibration information. A user measures light intensity of each local area emitted from the display unit 150 by using the sensor 200 connected to the display apparatus 100 or the computer 300 (600). The light intensity information measured for each local area is stored in a corresponding location of the memory that is reserved for that local area. If the sensor 200 is directly connected to the display apparatus 100, the light intensity information measured by the sensor 200 is sequentially stored in the display apparatus 100. If the sensor 200 is connected to the computer 300, the light intensity information is stored in the computer 300 before being transmitted to the display apparatus 100. If the light intensity of all local areas is measured, the non-uniformity correction for the display unit 150 is performed. To perform the non-uniformity correction, the light intensity data measured from the local area to which the non-uniformity correction is performed (i.e., the current local area) is compared with light intensity data of local areas measured previously (700). If there is a local area among the previously analyzed local areas within the error range according to the comparison result, the non-uniformity correction is performed on the current local area by using the calibration information of the local area stored in the storage unit 130 that is within the error range. If there is no local area among the previously analyzed local areas within the error range according to the search result of the storage unit 130, the calibration process is performed to the current local area and the non-uniformity correction is performed (800). This process is repeated for each local area until the last local area is compared to the previously analyzed local areas (900).

Referring to FIG. 6, a process of comparing color information and luminance information of each local area with color information and luminance information of local areas previously analyzed will be described.

Firstly, the color information of the current local area is compared with color information of local areas previously analyzed to identify whether there is a result within the error range (1100). The first error range may be set by a user. If there is no local area among the previously measures local areas within the first error range, the calibration process is performed to both color and luminance for the current local area (1200). If there is any local area among the previously analyzed local areas within the first error range, the luminance information of the current local area is compared with luminance information of the local areas previously analyzed to identify whether there is a result within a second error range (1300). If there is no local area among the previously analyzed local areas within the second error range, the calibration process is performed for only the luminance of the current local area. With respect to the color of the current local area, non-uniformity correction is performed by using the calibration information of the previously analyzed local area (1400). If there is any local area among the previously analyzed local areas within the second error range with respect to luminance, it means that the current local area is within the error range for both color and luminance. Thus, the non-uniformity correction is performed by using the calibration information of the previously analyzed local area (1500). This process is repeated until the last local area is compared to the previously analyzed local areas (1600). The order in which the color information is compared and the luminance information is compared to the light intensity data of previously analyzed local areas by be switched from the above example such that luminance information is compared in operation 1100 and color information is compared in operation 1300.

According to the exemplary embodiments, the calibration process is omitted with respect to similar local areas whose light intensity are within the error range, and the non-uniformity correction is performed by using the previous calibration information stored in memory to thereby reduce the entire calibration time and perform the non-uniformity correction within a short time.

As described above, a display apparatus having a uniformity adjustment function and a control method thereof according to the exemplary embodiments omits a calibration process for similar local areas whose light intensity is within an error range and performs a non-uniformity correction by using previous calibration information stored in memory to thereby reduce entire calibration time and perform non-uniformity adjustment within a short time.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus having a uniformity adjustment function, the display apparatus comprising:
a display unit which is divided into a plurality of local areas;
a signal receiver which receives from a sensor light intensity data of each local area of the plurality of local areas of the display unit; and
a controller which analyzes the plurality of local areas for non-uniformity correction by comparing a first light intensity data of a current local area with second light intensity data of local areas which have been previously analyzed for the non-uniformity correction, and, if any of the previously analyzed local areas is determined to have the second light intensity data within an error range of the first light intensity data of the current local area, the controller uses calibration information of the determined previously analyzed local area as calibration information for the current local area, and, if none of the previously analyzed local areas are determined to have the second light intensity data within the error range of the first light intensity data of the current local area, performs a calibration process with respect to the current local area, and outputs an image signal to the display unit.

2. The display apparatus according to claim 1, wherein the sensor comprises a calibrator.

3. The display apparatus according to claim 1, wherein the display unit is divided into the plurality of local areas by a user setting.

4. The display apparatus according to claim 1, further comprising a computer, wherein the computer stores therein the light intensity data of each of the local areas input by the sensor before transmitting the light intensity data to the display apparatus.

5. The display apparatus according to claim 1, wherein the light intensity data of each of the local areas comprise color information and luminance information, and, when comparing the first light intensity data of the current local area with the second light intensity data of the previously analyzed local areas, the controller compares first color information and first luminance information of the current local area with second color information and second luminance information of the previously analyzed local areas.

6. The display apparatus according to claim 5, wherein the controller compares the first color information of the current local area with the second color information of the previously analyzed local areas,
if none of the second color information of the previously analyzed local areas are within a first error range of the first color information of the current local area, the controller performs the calibration process with respect to both color and luminance of the current local area,
if a first result is received indicating that the determined previously analyzed local area has the second color information within the first error range of the first color information of the current local area, the controller compares the first luminance information of the current local area with the second luminance information of the previously analyzed local areas,
if none of the second luminance information of the previously analyzed local areas are within a second error range of the first luminance information of the current local area, the controller performs the calibration process with respect to the luminance of the current local area and uses the calibration information of the determined previously analyzed local area with respect to color, and
if a second result is received indicating that the determined previously analyzed local area has the second luminance information within the second error range of the first luminance information of the current local area, the controller uses the calibration information of the determined previously analyzed local area with respect to both color and luminance.

7. The display apparatus according to claim 5, wherein the display apparatus further comprises a storage unit, and the storage unit stores therein the color information, the luminance information and calibration information of each of the local areas.

8. The display apparatus according to claim 1, wherein the calibration information of the current local area comprises a coefficient value to adjust an RGB value of each pixel in the current local area.

9. The display apparatus according to claim 1, wherein the controller repeats a uniformity adjustment until a last local area among the plurality of local areas is compared to each of the previously analyzed local areas.

10. A uniformity adjustment method of a display apparatus, the method comprising:
dividing a display unit of the display apparatus into a plurality of local areas;
measuring a light intensity of each of the plurality of local areas by using a sensor;
comparing a first light intensity data measured for a current local area with second light intensity data of local areas which have been previously analyzed for the non-uniformity correction;
if any of the previously analyzed local areas is determined to have the second light intensity data within an error range of the first light intensity data of the current local area, using calibration information of the determined previously analyzed local area as calibration information for the current local area;
if none of the previously analyzed local areas are determined to have the second light intensity data within the error range of the first light intensity data of the current local area, performing a calibration process with respect to the local area; and
stopping the uniformity adjustment if a last local area is compared.

11. The method according to claim 10, wherein the sensor comprises a calibrator.

12. The method according to claim 10, wherein the light intensity data of each of the local areas comprise color information and luminance information, and the comparing the first light intensity data of the current local area with the second light intensity data of the previously analyzed local areas comprises comparing first color information and first luminance information of the current local area with second color information and second luminance information of the previously analyzed local areas.

13. The method according to claim 12, wherein,
if none of the second color information of the previously analyzed local areas are within a first error range of the first color information of the current local area, the calibration process is performed with respect to both color and luminance of the current local area,
if a first result is received indicating that the determined previously analyzed local area has the second color information within the first error range of the first color information of the current local area, comparing the first luminance information of the current local area with the second luminance information of the previously analyzed local areas,
if none of the second luminance information of the previously analyzed local areas are within a second error range of the first luminance information of the current local area, performing the calibration process with respect to the luminance of the current local area and using the calibration information of the determined previously analyzed local area with respect to color, and
if a second result is received indicating that the determined previously analyzed local area has the second luminance information within the second error range of the first luminance information of the current local area, using the calibration information of the determined previously analyzed local area with respect to both color and luminance.

14. The method according to claim 10, wherein the dividing the display unit into the plurality of local areas comprises generating a memory to store therein information of each of the plurality of local areas, and the information of each of the plurality of local areas comprises color information, luminance information and calibration information.

15. The method according to claim 10, wherein the calibration information of the current local area comprises a coefficient to adjust an RGB value of each pixel in the current local area.
